(19) United States
(12) Patent Application Publication
(10) Pub. No.: US 2009/0151347 A1
(43) Pub. Date: Jun. 18, 2009

(54) Operation Control Circuit for Construction Machine

(75) Inventors: Isao Nagatsuka, Saitama (JP); Shinichi Itou, Saitama (JP)

Correspondence Address: POSZ LAW GROUP, PLC, 12040 SOUTH LAKES DRIVE, SUITE 101, RESTON, VA, 20191, US

(73) Assignees: Komatsu Ltd., Tokyo (JP); Komatsu Utility Co., Ltd., Tokyo (JP)

(21) Appl. No.: 12/225,296

(22) PCT Filed: Mar. 20, 2007
(86) PCT No.: PCT/JP2007/055593

§ 371 Date: Nov. 18, 2008

(30) Foreign Application Priority Data
Mar. 22, 2006 (JP) 2006-078868

(51) Int. Cl. F15B 11/02

(52) U.S. Cl. 60/459

(57) ABSTRACT

The operation control circuit of the present invention reduces the speed of an actuator, such as a rotation motor, according to reduction in the rotational speed of an engine. When the engine rotational speed is at its maximum, a pilot pressure in a pilot conduit is set to a relief pressure of a relief valve. When the engine rotational speed is reduced, the flow rate of pilot pressure hydraulic fluid decreases, and the pressure difference over a throttle section becomes smaller than the relief pressure, so that the pilot pressure is set to the pressure difference. Even if the operator operates an operation lever to a full stroke position the spool valve does not go to the fully opened state, since the pressure is low. As a result, the flow rate of hydraulic fluid supplied to the rotation motor is reduced, so that the speed of rotation is reduced.

### TECHNICAL FIELD

The present invention relates to an operation control circuit for a construction machine.

### BACKGROUND ART

With a construction machine such as, for example, a hydraulic shovel or the like, there are provided a rotation motor for rotating the construction machine horizontally with respect to a running unit at its lower portion, and a plurality of actuators such as arm cylinders and the like. Each of these actuators operates by taking, as a power source, pressurized hydraulic fluid from a main pump which is driven by an engine.

Even when the engine is at its idling rotational speed, in order to make each of the actuators operate smoothly, working hydraulic fluid is supplied from the main pump to each of the actuators according to the load upon that particular actuator.

It should be understood that a load sensing technique for supplying working hydraulic fluid in an amount corresponding to the load upon an actuator is known (refer to Patent Document #1). Furthermore, a technique is known in which an accumulator is provided in a hydraulic fluid pressure circuit, and which can make it possible to operate the accumulator even after the engine is stopped (refer to Patent Document #2).

### Patent Document #1: Japanese Laid-Open Patent Publication 2003-343511.

### Patent Document #2: Japanese Laid-Open Patent Publication Showa 61-261535.

### SUMMARY OF THE INVENTION

### Problems at the Solution of which the Invention is Directed

When a structure is provided with which it is possible to operate an actuator at its maximum speed even when the engine is at its idling rotational speed, there is a possibility that it will not be possible to perform delicate operation when the engine is running at low speed. For example, in the case of a hydraulic shovel, the upper structure is rotated in the horizontal direction with respect to the lower travel unit by rotational operation of the rotation motor. If the speed of rotation is constant irrespective of the engine rotational speed, then it becomes difficult to perform delicate operation in which the working unit at the upper portion is gently rotated.

Due to this, for example, a structure has been contemplated with which a pump for rotation for driving the rotation motor is specially provided, and the discharge flow rate of this pump for rotation is made to be proportional to the engine rotational speed, or in which a load sensing pressure difference which is used by a load sensing mechanism is automatically compensated according to the engine rotational speed. However, with these types of solution strategy, the structure of the control circuitry becomes complicated, and the cost is also increased.

The present invention has been conceived in the light of the problems described above, and its object is to provide an operation control circuit for a construction machine, which makes it possible, with a comparatively simple structure, to reduce the speed of an actuator if the engine rotational speed has been reduced. Another object of the present invention is to provide an operation control circuit for a construction machine, which makes it possible to reduce the speed of an actuator if the engine rotational speed has been reduced, and also which makes it possible, even if the engine has been stopped, to operate the actuator with a pilot pressure hydraulic fluid which has been accumulated in an accumulator.

### Means for Solving the Problems

The operation control circuit for a construction machine according to the present invention includes: a pilot hydraulic fluid pressure source which is driven by an engine, and which supplies a pilot pressure hydraulic fluid to a pilot conduit at a flow rate which corresponds to engine rotational speed; an operation valve which is connected to the pilot hydraulic fluid pressure source via the pilot conduit, and which controls the operation of a control valve for controlling the flow rate of working hydraulic fluid supplied from a main hydraulic fluid pressure source to an actuator by supplying pilot pressure hydraulic fluid from the pilot hydraulic fluid pressure source to the control valve; a pressure adjustment valve which is provided partway along the pilot conduit, and which adjusts the pressure in the pilot conduit to a predetermined pressure (P1); and a throttle section which is provided to connect between partway along the pilot conduit and a tank. And, when the engine rotational speed of the engine has become less than or equal to a first engine rotational speed, the pressure difference before and after the throttle section is set so that its value becomes lower than the predetermined pressure.

Furthermore, there may also be included: an accumulator which is connected to the pilot conduit; a non return valve which is provided in the pilot conduit at a position between the connection point of the throttle section to the pilot conduit and the accumulator, and which stops the flow of pressurized hydraulic fluid from the accumulator towards the throttle section while permitting flow in the reverse direction; a changeover valve which is provided partway along the pilot conduit at a position between the non return valve and the accumulator, and which has a first position in which it stops flow of pressurized hydraulic fluid from the accumulator towards the pilot conduit while permitting flow in the reverse direction, and a second position in which it permits flow of pressurized hydraulic fluid from the accumulator towards the pilot conduit; and a detection means which detects whether or not the pilot hydraulic fluid pressure source is supplying pilot pressure hydraulic fluid to the pilot conduit; wherein the changeover valve is built so as, when the pilot hydraulic fluid pressure source is supplying pilot pressure hydraulic fluid, to be changed over to its first changeover position, and so as, when the pilot hydraulic fluid pressure source has stopped the supply of pilot pressure hydraulic fluid, to be changed over to its second changeover position.

Furthermore, it is also possible to provide a load sensing mechanism which controls the flow rate of working hydraulic fluid which is supplied from the main hydraulic fluid pressure source to the actuator, so that the pressure difference between the discharge pressure of the main hydraulic fluid pressure source and the load pressure of the actuator becomes constant.

### Benefits of the Invention

According to the present invention, since the pressure difference before and after the throttle section is reduced to below the predetermined pressure when the engine rotational speed becomes less than or equal to the first engine rotational speed, accordingly the pressure in the pilot conduit is adjusted by the throttle section to a value which is lower than the predetermined pressure. Due to this, the pressure of the pilot pressure hydraulic fluid which is supplied from the operation valve to the control valve is reduced, and the operation of the control valve is limited. As a result, the flow rate of the working hydraulic fluid which is supplied to the actuator is reduced, so that the speed of the actuator is reduced.

Moreover, according to the present invention, it is possible to prevent the operation of the accumulator exerting an influence upon the pressure control of the pilot pressure hydraulic fluid, and furthermore, when the engine has stopped, it is possible to operate the actuator using the pilot pressure hydraulic fluid which has been accumulated in the accumulator.

### PREFERRED EMBODIMENTS FOR IMPLEMENTATION OF THE INVENTION

In the following, embodiments of the present invention will be explained based upon the drawings. In these embodiments, as will be described in detail hereinafter, it is arranged to limit the operation of a spool valve for rotation 1, and to reduce the speed of a rotation motor 1A, by reducing the pressure in a pilot conduit 11 in correspondence to reduction of the rotational speed of an engine 5. In the following, by way of example, a case will be described of controlling the speed of a rotation motor 1A of a hydraulic shovel, which is taken as an example of a construction machine.

### Embodiment 1

FIG. 1 is a hydraulic fluid pressure circuit diagram showing the entirety of an operation control circuit 100 of a hydraulic shovel according to this embodiment. This operation control circuit 100 may be appropriately used for controlling the speed of rotation of the hydraulic shovel.

First, an example of the construction of the hydraulic shovel will be explained in a simple manner. This hydraulic shovel may comprise, for example, a lower travel unit which has a pair of left and right tracks, an upper working unit which is provided upon the lower travel unit so as to be rotatable, a construction machine which is provided at the front of the upper working unit, operating devices and mechanical devices which are provided to the upper working unit, and so on. These operating devices include an operation valve for rotation 12 which will be described hereinafter. And these mechanical devices include an engine 5, a main pump 4, a pilot pump 10, and so on, which will be described hereinafter.

The lower travel unit travels by driving the tracks with a hydraulic pressure motor. A rotation motor 1A is provided between the lower travel unit and the upper working unit, and the upper working unit may be rotated by driving this rotation motor 1A to rotate.

The construction machine may comprise, for example, a boom which is rotatably fitted to the upper working unit, an arm which is rotatably fitted to the end of the boom, and a bucket which is rotatably fitted to the end of the arm. The bucket may be rotated by a bucket cylinder 3A; the boom may be rotated by a boom cylinder 2A; and the arm may be rotated by an arm cylinder.

Thus various actuators are provided to this hydraulic shovel, such as, for example, the rotation motor 1A, the boom cylinder 2A, the bucket cylinder 3A, and so on. Although, apart from these, the hydraulic shovel may also be provided with other actuators such as an arm cylinder, a right side traveling motor, a left side traveling motor, and so on, for convenience upon the drawing paper, these are omitted from the drawing.

The rotation motor 1A is operated by a spool valve for rotation 1A, the boom cylinder 2A is operated by a spool valve for boom 2, and the bucket cylinder 3A is operated by a spool valve for bucket 3. Each of these spool valves 1, 2, and 3 supplies working hydraulic fluid, provided via a main conduit 6 from a main pump 4, to its respective actuator 1A, 2A, or 3A.

The main pump 4 supplies working hydraulic fluid for driving the actuators such as the rotation motor 1A and so on. This main pump 4 may be built as, for example, a gear pump or a swash plate type pump or the like. The drive shaft of the main pump 4 is connected to the rotation shaft of the engine 5, and thus the main pump 4 is driven by using the rotational drive of the engine 5 as a power source.

Here, a so called load sensing mechanism is provided, so as to keep constant the pressure difference between the pressure at the load side of the spool valves 1, 2, and 3, and the discharge pressure of the main pump 4. This load sensing mechanism may be, for example, housed internally within the spool valves 1, 2, and 3. The flow rate control by load sensing will be described hereinafter in connection with FIG. 2.

Next, the control circuit for operating the rotation motor 1A will be explained. As described above, this rotation motor 1A is for rotating the upper working unit of the hydraulic shovel with respect to the lower travel unit, and is controlled by the spool valve for rotation 1.

The spool valve for rotation 1 is connected to the main pump 4 via the main conduit 6, and controls the speed of rotation and the rotational direction of the rotation motor 1A by controlling the amount and the direction of the supply of working hydraulic fluid discharged from the main pump 4.

The spool valve for rotation 1 is actuated by the operation valve for rotation 12. The operation valve for rotation 12 constitutes a portion of the operating device which is provided to the upper working unit. This operation valve for rotation 12 controls the amount and the direction of the pilot pressure hydraulic fluid which is supplied to the spool valve for rotation 1, according to the amount of actuation and the direction of actuation of an operation lever 12A by the operator. And, by the amount and the direction of the pilot pressure hydraulic fluid being thus controlled, the operation of the spool valve for rotation 1 is controlled.

The pilot pressure hydraulic fluid is supplied by a pilot pump 10. This pilot pump 10 may, for example, be built as a gear pump or the like, and its drive shaft is connected to the rotation shaft of the engine 5. Accordingly, when the engine 5 is started, the pilot pump 10 starts its operation together with the main pump 4. The pilot pump 10 sucks in working hydraulic fluid within a tank 7, and discharges the pilot pressure hydraulic fluid from a discharge aperture.

A pilot conduit 11 is provided so as to connect between the discharge aperture of the pilot pump 10 and the flow inlet of the operation valve for rotation 12. The pilot pressure hydraulic fluid which is discharged from the pilot pump 10 is supplied to the operation valve for rotation 12 via this pilot conduit 11.

Here, a conduit 11A on the downstream side of the pilot conduit 11 is connected to the inflow port of a changeover valve for locking 18, so that the pilot conduit 11 is connected via the changeover valve for locking 18 to the operation valve for rotation 12.

This changeover valve for locking 18 is a valve which determines whether or not operation by the operation valve for rotation 12 is possible. By this changeover valve for locking 18 being actuated by the operator, it may be changed over between a position (a) in which it permits rotational operation, and a position (b) in which it prohibits rotational operation. When the changeover valve for locking 18 is changed over to its position (a), the operation valve for rotation 12 and the pilot conduit 11 are connected together via the changeover valve for locking 18. By contrast, when the changeover valve for locking 18 is changed over to its position (b), the operation valve for rotation 12 and the pilot conduit 11 are cut off from one another, and the pressurized hydraulic fluid is returned to the tank 7.

One end of a branch conduit 11B is connected partway along the pilot conduit 11, at a position between the downstream side conduit 11A and the discharge aperture of the pilot pump 10. The other end of this branch conduit 11B is connected to the tank 7. Since a throttle section 14 which will be described hereinafter is provided partway along the branch conduit 11B, accordingly, even when the operation of the pilot pump 10 has stopped, the pressure in the pilot conduit 11 does not directly drop down to the pressure in the tank. Moreover, the pilot conduit 11 is connected via a connection conduit 11C to an accumulator 16 which will be described hereinafter.

Partway along the pilot conduit 11, there is provided a relief valve 13 for adjusting the pressure in the pilot conduit 11 (i.e. the pilot source pressure) to a predetermined pressure P1. This predetermined pressure P1 may be set, for example, to a value around 30 kg/cm² (2942 kPa). This predetermined pressure P1 is a relief pressure. The relief valve 13 adjusts the pressure in the pilot conduit 11 to the pressure P1 by returning excess pilot pressure hydraulic fluid to the tank 7.

The throttle section 14 is also provided partway along the pilot conduit 11. This throttle section 14 is provided partway along the branch conduit 11B which branches off from partway along the pilot conduit 11 and communicates with the tank 7. The aperture area and so on of this throttle section 14 are set so that, when the engine rotational speed has dropped to less than or equal to a low idling rotational speed NL, then the pressure difference ΔP before and after the throttle section 14 becomes smaller than the predetermined pressure P1 (i.e. so that ΔP<P1). This pressure difference ΔP may, for example, be set to a value around 10 kg/cm² (980 kPa). The pressure adjustment function provided by this throttle section 14 will be further described hereinafter.

The accumulator 16 is connected to the pilot conduit 11 via the connection conduit 11C, and accumulates pilot pressure hydraulic fluid at the relief pressure (P1) while the pilot pump 10 is operating. And when the pilot pump 10 stops, i.e. when the engine 5 stops, the accumulator 16 is adapted to expel the pilot pressure hydraulic fluid which it has accumulated into the pilot conduit 11.

A non return valve 16 is provided partway along the pilot conduit 11, and is positioned between the throttle section 14 and the accumulator 16. In other words, this non return valve 15 is positioned more to the downstream side than the connection point between the branch conduit 11B and the pilot conduit 11, and is provided partway along the pilot conduit 11. The non return valve 15 prevents the pilot pressure hydraulic fluid which has been accumulated under pressure in the accumulator 16 from flowing towards the throttle section 14, while permitting flow in the reverse direction.

The changeover valve 17 is a hydraulic changeover valve for controlling the operation of the accumulator 16. This changeover valve 17 for accumulator control is positioned between the non return valve 15 and the accumulator 16, and is provided partway along the pilot conduit 11. And this changeover valve 17 has a first position (a) and a second position (b).

When the changeover valve 17 is changed over to its first position (a), flow of the pilot pressure hydraulic fluid from the accumulator 16 towards the pilot conduit 11 is stopped, while flow of the pilot pressure hydraulic fluid from the pilot conduit 11 towards the accumulator 16 is permitted. And, when the changeover valve 17 is changed over to its second position (b), the pilot pressure hydraulic fluid which has accumulated in the accumulator 16 flows into the pilot conduit 11.

The changeover valve 17 is adapted to change over between its first position (a) and its second position (b) due to pressure received from the pilot conduit 11. In other words, the pressure detected from the pilot conduit 11, which is positioned between the pilot pump 10 and the non return valve 15, is inputted to the changeover valve 17 via a pressure detection conduit 17A.

When pressure is being generated within the pilot conduit 11, due to this pressure, which is conducted from the pilot conduit 11 via the pressure detection conduit 17A, the changeover valve 17 is changed over to its first position (a) against the resistance of a spring force. And, when the pressure within the pilot conduit 11 reduces to the neighborhood of zero, the changeover valve 17 is changed over from its first position (a) to its second position (b) under the influence of the spring force.

In other words, the changeover valve 17 is changed over to its first position (a) while the engine 5 is started and the pilot pump 10 is operating. Due to this, a portion of the pilot pressure hydraulic fluid within the pilot conduit 11 flows into the accumulator 16, and is accumulated within the accumulator 16. Furthermore, when the changeover valve 17 is changed over to its first position (a), the flowing in of pilot pressure hydraulic fluid from the accumulator 16 to the pilot conduit 1 is prohibited. Accordingly no influence upon the pilot pressure hydraulic fluid is experienced from the accumulator 16, and the pressure in the pilot conduit 11 can be adjusted to a comparatively low value by the throttle section 14.

Next, the method of adjusting the pressure in the pilot conduit 11 will be explained. If the discharge capacity of the pilot pump 10 is termed q (in cc/rev), and a predetermined coefficient is termed ηv, then, when the engine rotational speed is at the full rotational speed (NH (rpm)), the flow rate QH of the pilot pressure hydraulic fluid which is discharged from the pilot pump 10 may be obtained from Equation 1 below:

QH=ηv·q·NH/1000 (Equation 1)

In a similar manner, when the engine rotational speed is at the idling rotational speed (NL (rpm)), the flow rate QL of the pilot pressure hydraulic fluid which is discharged from the pilot pump 10 may be obtained from Equation 2 below:

QL=ηv·q·NL/1000 (Equation 2)

And, if the flow rate passing through the throttle section 14 is termed Qa, the throttle aperture area is termed A (mm̂2), the flow rate coefficient is termed C, and the pressure difference across the throttle section 14 is termed ΔP, then the pressure-flow rate characteristic of the throttle section 14 is given by Equation 3 below:

ΔP=(Qa/C·A)̂2 (Equation 3)

Accordingly, the pressure difference ΔP over the throttle section 14 when the engine rotational speed is at the full rotational speed NH becomes C=(QH/C·A)̂2. And ΔP when the engine rotational speed is at the idling rotational speed NL becomes ΔP=(QL/C·A)̂2.

In this embodiment, the discharge capacity q of the pilot pump 10 and the throttle aperture area A are set so that the value of ΔP at the full rotational speed NH becomes greater than the relief pressure P1 which is a predetermined pressure (i.e. ΔP>P1), and moreover so that, at least, the value of ΔP at the idling rotational speed NL becomes less than the relief pressure P1 (i.e. ΔP<P1).

If ΔP>P1 is valid, then, since the relief pressure P1 is the lower, accordingly the pressure in the pilot conduit 11 is adjusted by the relief valve 13 to the comparatively high value of P1. By contrast, if ΔP<P1 is valid, then, since the pressure difference Δp across the throttle section 14 is the lower, accordingly the pressure in the pilot conduit 11 is adjusted by the throttle section 14 to the comparatively low value of ΔP.

In other words, with the operation control circuit of this embodiment, the more the flow rate of the pilot pressure hydraulic fluid is reduced due to reduction of the engine rotational speed, the more is the pilot pressure also reduced from P1. That is to say, the pilot pressure is controlled so as to be reduced, according to reduction of the engine rotational speed.

FIG. 2 is a characteristic diagram showing a flow rate—engine rotational speed characteristic which expresses the gist of the flow rate control according to this load sensing mechanism. Due to the engine 5 being started, the main pump 4 discharges working hydraulic fluid to the main conduit 6. The thick line in FIG. 2 shows the flow rate change of the working hydraulic fluid which is supplied from the main conduit 6 via the spool valve for rotation 1 to the rotation motor 1A. And the thin line in FIG. 6 shows the total discharge amount of the main pump 4.

When the engine rotational speed is at the idling rotational speed NL, a predetermined flow rate Qm is supplied to the rotation motor 1A. Thereafter, until the engine rotational speed rises up to the full rotational speed NH, working hydraulic fluid is stably supplied to the rotation motor 1A in the constant amount Qm. This predetermined flow rate Qm may be set to a value which is sufficient for rotation of the rotation motor 1 at its highest speed.

Due to the load sensing, it becomes possible to supply the stabilized flow rate Qm to the rotation motor 1A, irrespective of the state of operation of the other actuators 2A and 3A, and irrespective of the engine rotational speed.

Accordingly, if the present invention is not applied, it is possible to rotate the hydraulic shovel at its maximum speed of rotation with the engine rotational speed still at its idling rotational speed. However, in the vehicle stopped state or the low speed state, the operator wants a more gentle speed of rotation if he performs a minute actuation.

Thus, in this embodiment, the pilot pressure is adjusted in a variable manner by connecting the throttle section 14 in parallel with the pilot conduit 11 in addition to the relief valve 13, so that the speed of the rotation motor 1A is controlled.

In the following, the operation of the operation control circuit according to this embodiment will be explained using FIGS. 3 through 6. In FIGS. 3 through 5, for the convenience of explanation, a portion of the circuit shown in FIG. 1 is shown as picked out.

FIG. 3 shows the situation when the engine 5 is rotating at its full rotational speed NH. In this case, the flow rate of the pilot pressure hydraulic fluid which is discharged from the pilot pump 10 is large, and the relief pressure P1 of the relief valve 13 becomes lower than the pressure difference ΔP over the throttle section 14. Accordingly, the pressure in the pilot conduit 11 is adjusted to the relief pressure P1 (pilot pressure=P1).

And the pilot pressure hydraulic fluid at the pressure P1 is supplied from the pilot conduit 11 to the operation valve for rotation 12. When the operator actuates the operation valve for rotation 12, pilot pressure hydraulic fluid at the pressure P1 is supplied to the spool valve for rotation 1, and the spool valve for rotation 1 operates. Due to this, the rotation motor 1A rotates, and the hydraulic shovel rotates in the direction desired by the operator.

Moreover, a portion of the pilot pressure hydraulic fluid at the pressure P1 flows from the pilot conduit 11 via the connection conduit 11C and the changeover valve 17 into the accumulator 16. Due to this, the accumulator 16 accumulates pilot pressure hydraulic fluid at the pressure P1.

FIG. 4 shows the situation when the engine 5 is rotating at its idling rotational speed NL. In this case, the flow rate of the pilot pressure hydraulic fluid which is discharged from the pilot pump 10 is reduced, and the pressure difference ΔP over the throttle section 14 is reduced to below the relief pressure P1. Accordingly, the pressure in the pilot conduit 11 is adjusted to the pressure difference ΔP (pilot pressure=ΔP<P1).

Since the pressure within the accumulator 16 is P1, this pressure P1 within the accumulator 16 is higher than the pressure ΔP within the pilot conduit 11. However, due to the pressure ΔP in the pilot conduit 11, the changeover valve 17 is still kept changed over to its first position (a). Accordingly, the pressurized hydraulic fluid within the accumulator 16 does not flow into the pilot conduit 11. It should be understood that, since the pressure ΔP in the pilot conduit 11 is lower than the pressure P1 within the accumulator 16, accordingly the pilot pressure hydraulic fluid does not flow from the pilot conduit 11 to the accumulator 16.

When the pressure in the pilot conduit 11 has reduced to ΔP, if the operator actuates the operation valve for rotation 12 with the operation lever 12A, pilot pressure hydraulic fluid at low pressure (ΔP) is supplied to the spool valve for rotation 1. Since the pressure of this pilot pressure hydraulic fluid is low, the valve body of the spool valve for rotation 1 is not shifted as far as its full stroke, and the aperture area of the spool valve 1 is limited. Accordingly, the flow rate of the working hydraulic fluid which is supplied from the main pump 4 to the rotation motor 1A is also reduced, and the speed of the rotation motor 1A is reduced. Due to this, the hydraulic shovel can be rotated at a comparatively gentle speed, even if the operator has actuated the operation lever 12A as far as its full stroke position.

And FIG. 5 shows the case when the engine 5 is stopped. When the engine 5 is stopped, the operation of the main pump 4 and the pilot pump 10, which use the rotational power of the engine 5 as a drive source, is also stopped. The pilot pressure hydraulic fluid which remains within the pilot conduit 11 returns via the throttle section 14 to the tank 7, and the pressure in the pilot conduit 11 approaches zero.

When the pressure in the pilot conduit 11 thus drops and falls below the spring force of the changeover valve 17, the changeover valve 17 changes over from its first position (a) to its second position (b). Due to this, the pilot pressure hydraulic fluid at the pressure P1 which has accumulated in the accumulator 16 flows via the connection conduit 11C into the pilot conduit 11.

Since the non return valve 15 is provided between the accumulator 16 and the throttle section 14, accordingly the pressurized hydraulic fluid which has flowed from the accumulator 16 into the pilot conduit 11 does not flow via the throttle section 14 into the tank 7.

In this manner, after the engine has stopped, after the pressure in the pilot conduit 11 has temporarily reduced to a value which is smaller than ΔP, it then elevates up to P1 due to the position of the changeover valve 17 changing over. Accordingly, the operator is able to utilize the pilot pressure hydraulic fluid which is expelled from the accumulator 16, and is able to operate the spool valve for rotation 1. Due to this, the operator is able to rotate the hydraulic shovel, so as for example to put it into a safe attitude.

FIG. 6 is a characteristic diagram showing the situation when the speed of rotation is adjusted. FIG. 6(a) is a characteristic figure showing the relationship between the stroke amount of the operation lever 12A and the flow rate Qm of the working hydraulic fluid supplied to the rotation motor 1A. The double dotted broken line in FIG. 6(a) shows the characteristic at full rotational speed, and the thick line shows the characteristic at idling rotational speed.

At full rotational speed, the flow rate of working hydraulic fluid supplied to the rotation motor 1A is increased according to the amount of actuation of the operation lever 12A. At least when the operation lever 12A is actuated as far as its full stroke position (Lmax), the working hydraulic fluid flow rate arrives at its maximum value Qmh. By contrast, at idling rotational speed, even if the operation lever 12A is actuated to its full stroke position, the working hydraulic fluid flow rate does not reach the maximum flow rate Qmh. Since the spool valve for rotation 1 does not fully open at the idling rotational speed, the flow rate of working hydraulic fluid which is supplied to the rotation motor 1A becomes a value Qm1 which is lower than Qmh (Qm1<Qmh).

FIG. 6(b) is a characteristic diagram showing the relationship between the engine rotational speed and the speed of rotation. As described above, when the engine rotational speed drops, the speed of rotation also drops, since the flow rate of the working hydraulic fluid which is supplied to the rotation motor 1A also drops. If the maximum speed of rotation when the engine 5 is rotating at full speed is termed VH, then the speed of rotation when the engine 5 is rotating at idling speed becomes VL (where VL<VH).

In this embodiment, as described above, it is possible to control the pilot pressure according to the engine rotational speed by setting the throttle section 14 in the pilot conduit 11. By doing this, it is possible to reduce the speed of rotation according to the engine rotational speed with a comparatively simple structure, so that the convenience of use is enhanced.

In this embodiment, it is arranged to provide the changeover valve 17 for preventing the pilot pressure hydraulic fluid in the accumulator 16 from flowing into the pilot conduit 11, until the engine 5 stops and the pilot pressure sufficiently reduces. Accordingly, if the engine rotational speed has dropped, the pilot pressure is made to reduce rapidly due to the throttle section 14, so that it is possible to reduce the speed of rotation. If the changeover valve 17 were not to be provided, then, when the engine rotational speed drops and the pilot pressure drops lower than P1, the pilot pressure hydraulic fluid at the pressure P1 within the accumulator 16 would directly flow into the pilot conduit 11. Accordingly, the adjustment of the pilot pressure by the throttle section 14 would be delayed due to the operation of the accumulator 16. By contrast, in this embodiment, since the operation of the accumulator 16 is controlled by the changeover valve 17, it is possible to reduce the pilot pressure rapidly corresponding to reduction of the engine rotational speed, so that the convenience of use is enhanced.

In this embodiment, by providing the non return valve 15 between the throttle section 14 and the accumulator 16, the pilot pressure hydraulic fluid supplied from the accumulator 16 can be prevented from flowing into the tank 17 via the throttle section 14. Due to this, the function of the accumulator 16 to ensure an opportunity for operation after the engine has stopped is not lost, so that the convenience of use and the reliability are enhanced.

### Embodiment 2

FIG. 7 is a circuit diagram of a second embodiment of the present invention. In this embodiment, a pressure sensor 20 is used as a means for detecting the pressure in the pilot conduit 11. Furthermore, the changeover valve 17 for accumulator control of this embodiment is built as an electromagnetic type changeover valve.

Since the other structures are the same as in the first embodiment, explanation thereof will be omitted, and the explanation will focus upon the structure which is characteristic of this embodiment.

The pressure sensor 20 outputs an electrical signal if the pressure in the pilot conduit 11 is larger than a predetermined set pressure (zero or a value in the neighborhood of zero). The changeover valve 17 is kept in its first position (a) by the electrical signal from the pressure sensor 20. When the engine 5 stops and the pressure in the pilot conduit 11 drops to below the set pressure, the electrical signal from the pressure sensor 20 ceases. Due to this, the changeover valve 17 changes over from its first position (a) to its second position (b). Thus, with this embodiment having the above structure, similar advantageous effects can be obtained as in the case of the first embodiment above.

### Embodiment 3

FIG. 8 is a circuit diagram of a third embodiment of the present invention. In this embodiment, a sensor 30 is provided for detecting the operational state of the engine 5, and the electromagnetic type changeover valve 17 is changed over by the signal from this sensor 30.

The sensor 30 may, for example, detect whether or not the engine 5 is started, and may output its electrical signal, based upon the fuel injection amount or the engine rotational speed or the like, If the engine 5 is started, the pilot pump 10 is also operating, and the pilot pressure is being generated. By contrast, since the operation of the pilot pump 10 also stops if the engine 5 is stopped, then the pilot pressure drops to zero or to the neighborhood of zero.

Accordingly, it is possible to detect the presence or absence of the pilot pressure indirectly by detecting the starting state of the engine 5. It should be understood that it is considered that a certain delay time period is present from when the engine 5 stops until the pilot pressure drops to zero or to the neighborhood of zero. Accordingly, the time period for the output signal of the sensor 30 to transit from “engine started” to “engine stopped” may be adjusted in consideration of this delay time period.

Thus, with this embodiment having the above structure, similar advantageous effects can be obtained as in the case of the first embodiment above.

### Embodiment 4

FIG. 9 is a circuit diagram of a fourth embodiment of the present invention. In this embodiment, the structures related to the non return valve 15, the accumulator 16, and the changeover valve 17 are removed from the circuit shown in FIG. 1. The other structures are the same as in the first embodiment.

It is also possible to utilize a structure as in this embodiment, if the function for ensuring the opportunity of actuation after the engine has stopped by the accumulator 16 is not required.

It should be understood that the present invention is not limited to the embodiments described above. For a person skilled in the art, it would be possible to make various additions and changes and so on, within the scope of the present invention.

For example, the present invention could also be applied to an actuator other than a rotation motor (a boom cylinder, an arm cylinder, a travel motor, or the like). Furthermore, although the present invention has been explained by citing a hydraulic shovel as an example of a construction machine, this is not limitative; the present invention could also be applied to some other type of construction machine, such as, for example, a hydraulic crane vehicle or the like. Moreover although, in the third embodiment, a case was described in which starting of the engine was detected electrically, instead of this it would also be acceptable, for example, to detect the rotational motion of the crank shaft mechanically, and to change over the changeover valve for accumulator control according thereto.

### BRIEF DESCRIPTION OF THE DRAWINGS

FIG. 1 is a circuit diagram of an operation control circuit;

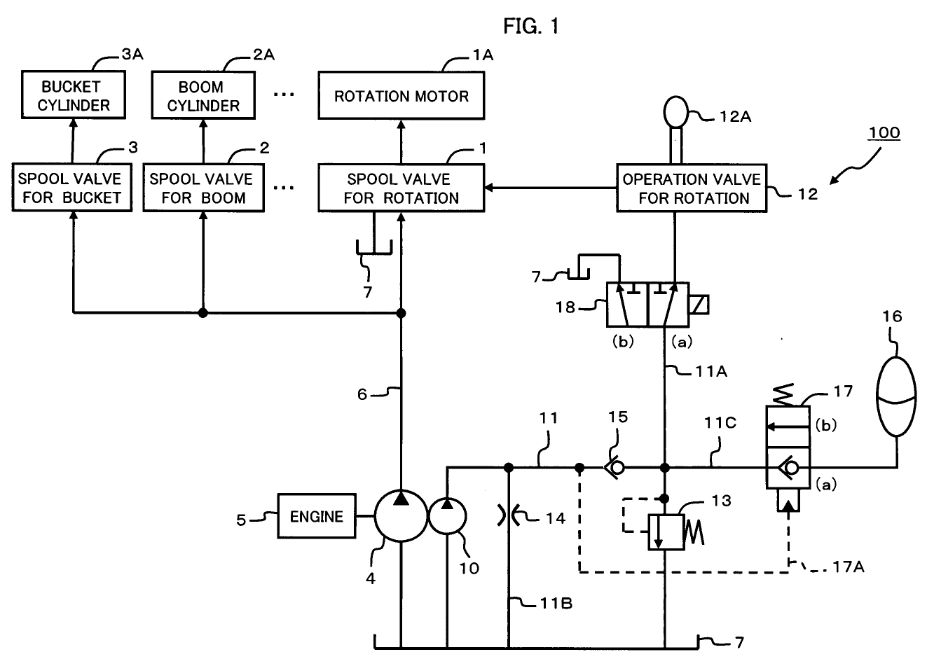

FIG. 2 is a characteristic diagram showing the relationship between the flow rate of working hydraulic fluid supplied to a rotation motor, and engine rotational speed;

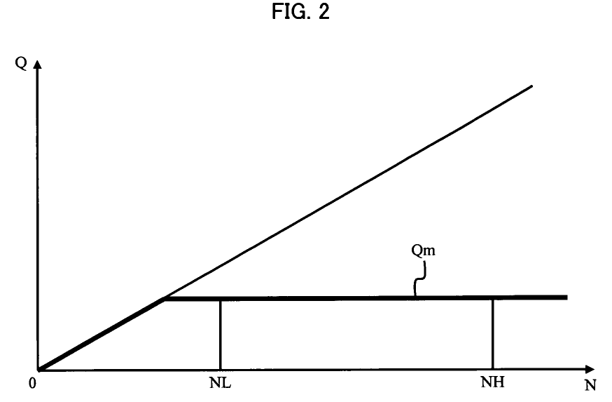

FIG. 3 is a circuit diagram showing the situation when an engine is rotating at full rotational speed;

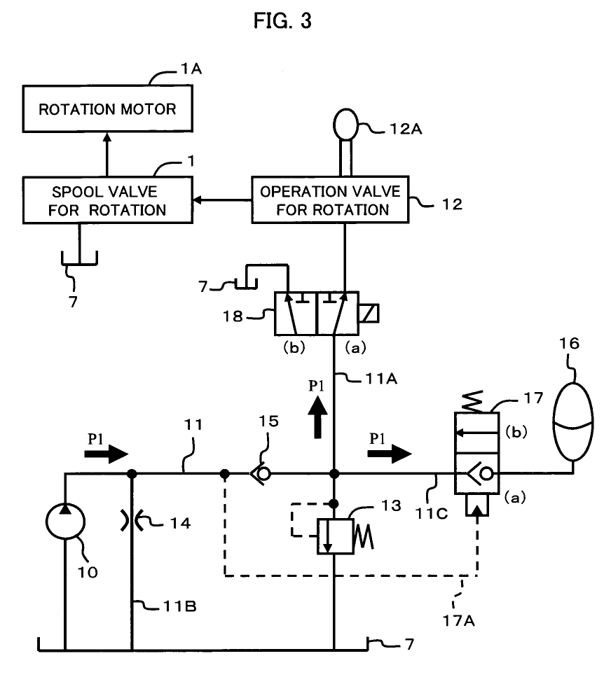

FIG. 4 is a circuit diagram showing the situation when the engine is rotating at idling rotational speed;

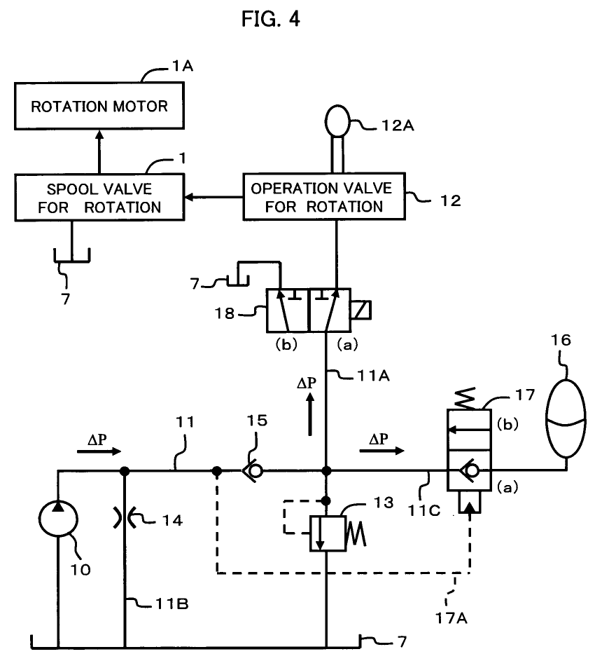

FIG. 5 is a circuit diagram showing the situation when the engine is stopped;

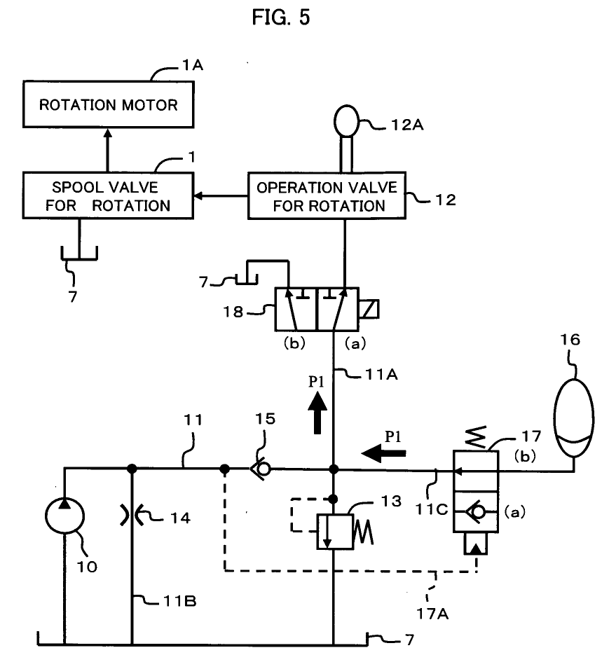

FIG. 6(a) is a characteristic diagram showing the relationship between the amount of actuation of an operation lever and the flow rate of working hydraulic fluid supplied to the rotation motor, and FIG. 6(b) is a characteristic diagram showing the relationship between the engine rotational speed and a speed of rotation;

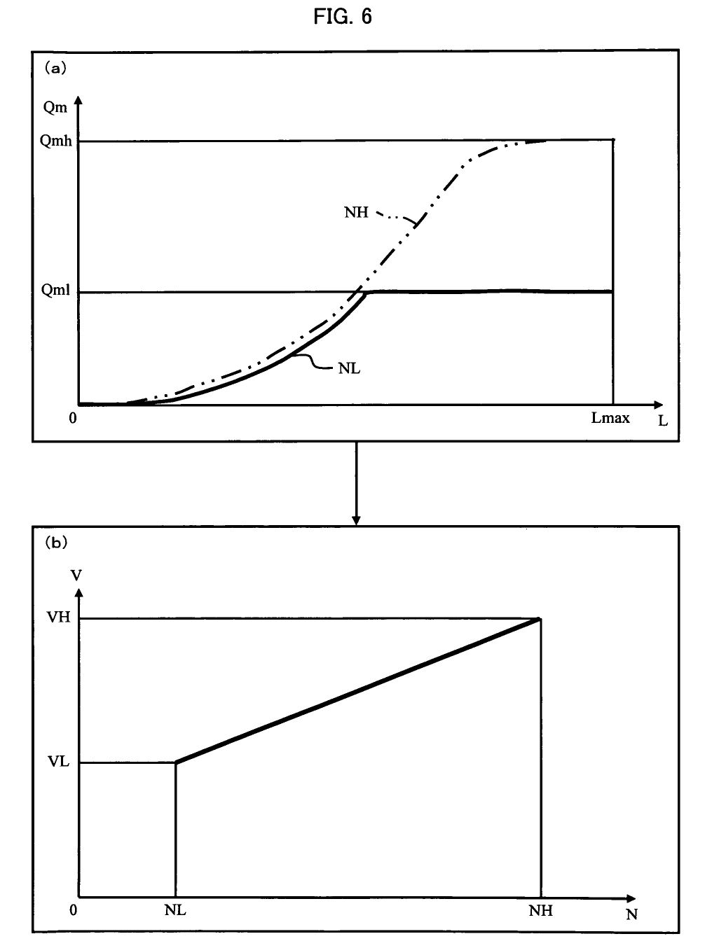

FIG. 7 is a circuit diagram for an operation control circuit according to a second embodiment of the present invention;

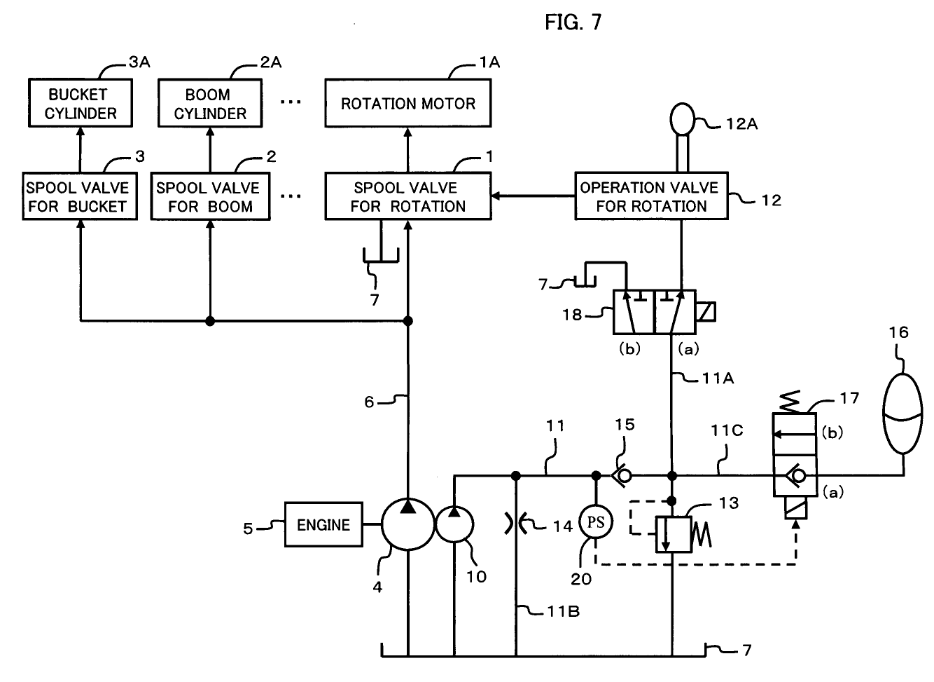

FIG. 8 is a circuit diagram for an operation control circuit according to a third embodiment of the present invention; and

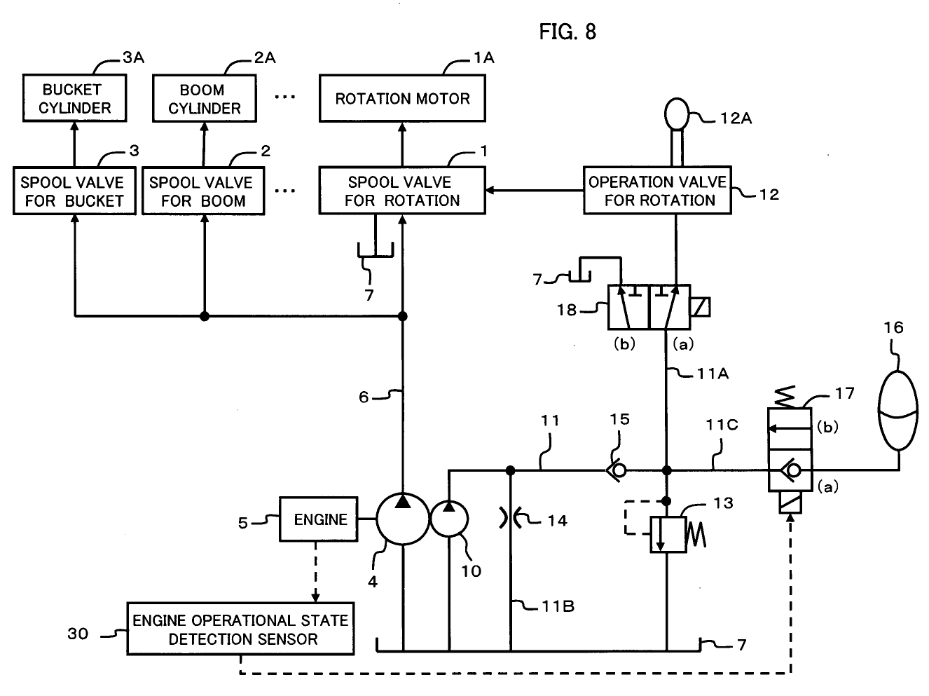

FIG. 9 is a circuit diagram for an operation control circuit according to a fourth embodiment of the present invention.

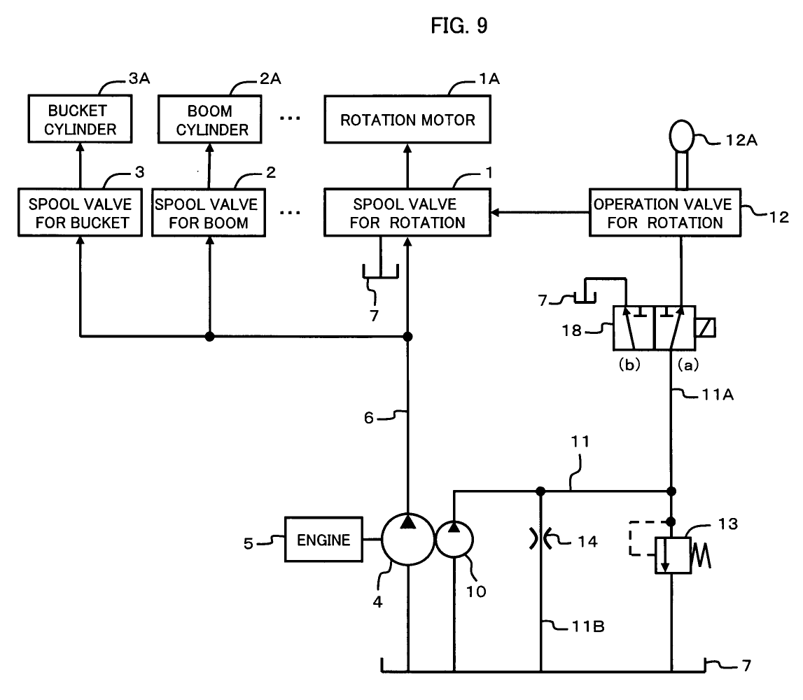

### EXPLANATION OF THE REFERENCE SYMBOLS

1: spool valve for rotation, 1A: rotation motor, 2: spool valve for boom, 2A: boom cylinder, 3: spool valve for bucket, 3A: bucket cylinder, 4: main pump, 5: engine, 6: main conduit, 7: tank, 10: pilot pump, 11: pilot conduit, 11A: downstream side conduit, 11B: branch conduit, 11C: connection conduit, 12: operation valve for rotation, 12A: operation lever, 13: relief valve, 14: throttle section, 15: non return valve, 16: accumulator, 17: changeover valve, 17A: pressure detection conduit, 18: changeover valve for locking, 20: pressure sensor, 30: engine operational state detection sensor, P1: relief pressure, ΔP: pressure difference over throttle section.

1. An operation control circuit for a construction machine, comprising:
a pilot hydraulic fluid pressure source which is driven by an engine, and which supplies a pilot pressure hydraulic fluid to a pilot conduit at a flow rate which corresponds to an engine rotational speed;
an operation valve which is connected to said pilot hydraulic fluid pressure source via said pilot conduit, and which controls an operation of a control valve for controlling a flow rate of working hydraulic fluid supplied from a main hydraulic fluid pressure source to an actuator by supplying the pilot pressure hydraulic fluid from said pilot hydraulic fluid pressure source to said control valve;
a pressure adjustment valve which is provided partway along said pilot conduit, and which adjusts the pressure in said pilot conduit to a predetermined pressure; and
a throttle section which is provided to connect between partway along said pilot conduit and a tank;
wherein, when the engine rotational speed of said engine has become less than or equal to a first engine rotational speed, a pressure difference before and after said throttle section is set so that its value becomes lower than said predetermined pressure.

2. The operation control circuit for a construction machine according to claim 1, further comprising:
an accumulator which is connected to said pilot conduit;
a non return valve which is provided in said pilot conduit at a position between connection point of said throttle section to said pilot conduit and said accumulator, and which stops flow of pressurized hydraulic fluid from said accumulator towards said throttle section while permitting flow in the reverse direction;
a changeover valve which is provided partway along said pilot conduit at a position between said non return valve and said accumulator, and which has a first position in which it stops flow of pressurized hydraulic fluid from said accumulator towards said pilot conduit while permitting flow in the reverse direction, and a second position in which it permits flow of pressurized hydraulic fluid from said accumulator towards said pilot conduit; and
a detection means which detects whether or not said pilot hydraulic fluid pressure source is supplying pilot pressure hydraulic fluid to said pilot conduit;
wherein said changeover valve is built so as, when said pilot hydraulic fluid pressure source is supplying pilot pressure hydraulic fluid, to be changed over to its first changeover position, and so as, when said pilot hydraulic fluid pressure source has stopped the supply of pilot pressure hydraulic fluid, to be changed over to its second changeover position.

3. The operation control circuit for a construction machine according to claim 2, further comprising a load sensing mechanism which controls the flow rate of working hydraulic fluid which is supplied from said main hydraulic fluid pressure source to said actuator, so that a pressure difference between the discharge pressure of said main hydraulic fluid pressure source and a load pressure of said actuator becomes constant.
